(19) United States
(12) Patent Application Publication
(10) Pub. No.: US 2008/0168628 A1
(43) Pub. Date: Jul. 17, 2008

(54) Handle For A Cleaning Device

(75) Inventors: Falk Lindner, Hemsbach (DE); Petra Bargon, Weinheim (DE); Keijo Lindholm, Salo (FI); Elisabeth Arnberg, Norrkoping (SE); Petteri Ojamo, Espoo (FI); Marcus Heneen, Stockholm (SE); Malin Oreback, Stockholm (SE); Sven-Eric Juhlin, Stockholm (SE); Olle Bobjer, Spanga (SE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Carl Freudenberg KG, Weinheim (DE)

(21) Appl. No.: 11/908,564

(22) PCT Filed: Feb. 22, 2006
(86) PCT No.: PCT/EP2006/001595

§ 371 Date: Sep. 13, 2007

(30) Foreign Application Priority Data
Mar. 18, 2005 (DE) 10 2005 013 084.4

(51) Int. Cl. B25G 1/00

(52) U.S. Cl. 16/430

(57) ABSTRACT

The invention relates to a handle (1) for a cleaning device. Said handle comprises at least one handle base (2) having at least one convex first handle section (3) and, axially adjacent to the first handle section, at least one concave second handle section (4). The invention is characterized in that the first handle section has a higher coefficient of static friction than the second handle section.

### TECHNICAL FIELD

The invention relates to a handle for a cleaning device, comprising a handle base with at least two axially adjacent handle sections.

### STATE OF THE ART

Handles for cleaning devices frequently include a handle base of solid plastic and are cylindrical in shape. The ability to cover a large surface area and easy handling of the cleaning device are particularly required in cleaning work in the professional sector. At the same time, particularly in the case of firmly adhering dirt, reliable force transmission to the cleaning device is necessary to achieve the necessary dislodging effect.

A handle for tools, particularly screwdrivers, is known from EP 0 208 942 A2. The handle is made from two materials of different hardness divided into handle areas, wherein one handle area made of a harder material is arranged between two handle areas made of a softer material.

### PRESENTATION OF THE INVENTION

The invention is based on the problem of improving the ergonomics of the handle.

This problem is solved by the characteristics of claim 1. The dependent claims relate to advantageous embodiments.

To solve the problem, the first handle section is convex in design, and the second handle section is concave in design; and the first handle section presents a higher coefficient of static friction than the second handle section.

The first handle section has a particularly ergonomic form due to its convex shape and is advantageously well suited to allow the hand to surround it. The first handle section presents a higher coefficient of static friction, ensuring a reliable force transmission, and the capability of applying a sufficiently strong force to the cleaning device in the case of firmly adhering dirt. The second handle section, as a result of the concave design, is a sliding section. The waist provided in the second handle section particularly ensures the sliding of the handle section through the depression between the index finger and thumb. To improve the sliding behavior, the second handle section presents a smaller coefficient of static friction than the first handle section. Because the convex handle section and the concave handle section are arranged adjacent to each other, they do not have to be enclosed by the hand during rapid handling operations.

The first handle section can present a larger diameter than the second handle section. Here, the diameter is here determined at the widest place of the convex shape and at the narrowest place of the concave shape. It is particularly advantageous and ergonomic here to design the curvatures of the two handle sections so that they result in continuous transitions between the handle sections.

The first handle section can present a greater surface roughness than the second handle section. Different surface roughnesses can be manufactured in a simple and cost advantageous manner. The handle section with rough design here presents a higher coefficient of static friction than the handle section with a smooth design. Here, the two handle sections can be made of the same material.

The first handle section can be formed from a thermoplastic elastomer and the second handle section from a thermoplastic. The second handle section here can be made from polypropylene. Polypropylene is cost-effective and is easily processed by the injection molding method. The thermoplastic elastomer used for the first handle section is also easily processed and presents a comfortable handle. The thermoplastic elastomer here presents a higher coefficient of static friction than polypropylene. It is advantageous here that the cleaning device can be leaned against a wall, and the high coefficient of static friction prevents the cleaning device from sliding.

The material of the first handle section can present a lower Shore hardness than the material of the second handle section. As a result, the first handle section presents a particularly convenient handle, which is gentle on the hands, as well as a high coefficient of static friction.

The free end of the handle can present a spherical segment-like third handle section, which is made of the same material as the second handle section. The third handle section is designed, like the second handle section, as a sliding element. The third handle section allows the cleaning device to slide against the inner surface of the hand, which makes it possible to rotate the cleaning device rapidly.

At least one additional handle base, which presents additional handle sections with convex and concave design, can be associated with the middle section on the handle. The additional handle sections present an additional ergonomic support area for cleaning personnel. As a result, the handle presents handle sections for both hands.

The additional handle sections can be made of the same material. As a result, the additional handle sections can be manufactured in a simple and cost effective way. In other embodiments, the additional handle sections can also present sections having different coefficients of static friction and can be made from different materials.

A color-coded ring can be associated with the handle. The color coding makes it possible to assign certain colors to certain properties of the cleaning device, for example, abrasiveness, absorption capacity, or effectiveness against certain types of dirt. The colors make it easy to distinguish the different cleaning devices. Using color coding, it is also possible to assign certain colors to certain cleaning tasks.

The ring can present an axially running slit, where the slit, on the side of the internal periphery, presents a positive-fit profile, which can be introduced into a handle base, whose shape presents a corresponding counter-profile. The ring is held here by a frictional connection to the handling element. The connection, while providing a solid hold, can be undone in a simple and nondestructive way, so that the rings can be simply exchanged.

### BRIEF DESCRIPTION OF THE DRAWING

Several embodiment examples of the handle according to the invention are explained in greater detail below with reference to the figures. In the drawing, the figures show schematically:

FIG. 1 a handle according to the invention;

FIG. 2 a handle with additional handle sections in the middle area of the handle; and

FIG. 3 the color-coded ring.

### EMBODIMENT OF THE INVENTION

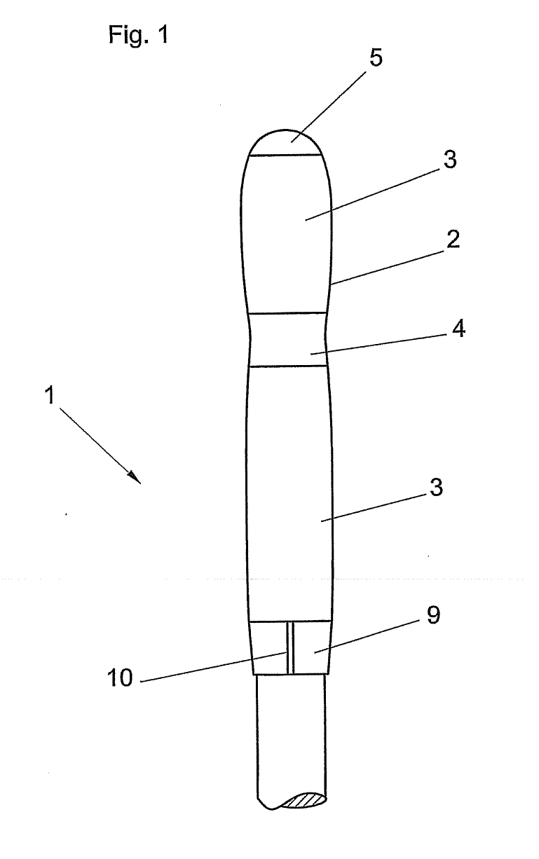

FIG. 1 shows a handle 1 with a handle base 2 which presents two first handle sections 3 of convex design. A second handle section 4 of concave design is arranged adjacent to the first handle section 3, axially on each front side. The first convex handle sections 3 present a larger diameter than the concave second handle section 4. The second handle section 4 is thus arranged between the first handle sections 3, resulting in a waist-like geometry. A waist-like geometry is particularly ergonomic. The design of the transitions between the handle sections 3, 4 is continuous. A spherical segment-like third handle section 5, which is associated with the front side of the first handle section 3, is arranged at the free end of the handle 1. In this embodiment, the first handle section 3 is formed from a thermoplastic material, and the second handle section 4 from a thermoplastic. Here, the first handle section 3, on the one hand, presents a higher coefficient of static friction than the second handle section 4, and, on the other hand, the material of the first handle section 3 presents a lower Shore hardness than the material of the second handle section 4. A color-coded ring 9 is associated with the handle 1. The ring 9 presents an axially running slit 10, which presents a positive-fit profile 11, which is formed on the side of the internal periphery in the form of a dovetail, and which is introduced into the corresponding counter-profile 12 of the handle base. The ring 9 is held by friction.

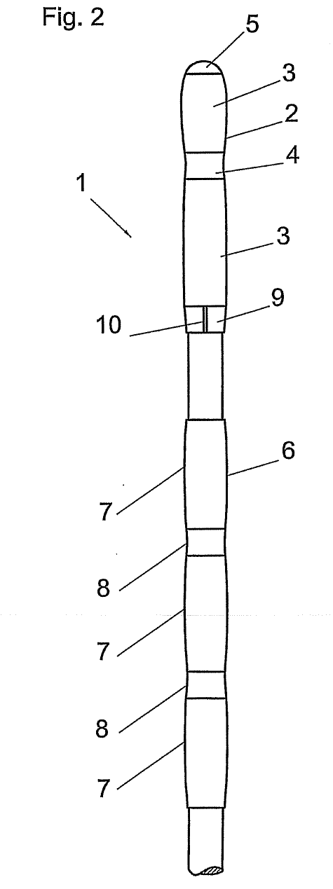

FIG. 2 shows a handle according to FIG. 1, where the different coefficients of static friction result in the design with different surface roughnesses for the handle sections 3, 4. Here, the first handle section 3 has greater surface roughness than the second handle section 4. In addition, in this design the handle sections 3, 4 are made of the same material and are in one piece. An additional handle base 6 is associated with the middle section of the handle 1. The additional handle base 6 presents additional handle sections 7, 8 with convex and concave shapes. Here, the additional handle sections 7, 8 are made of the same material and present continuous transitions.

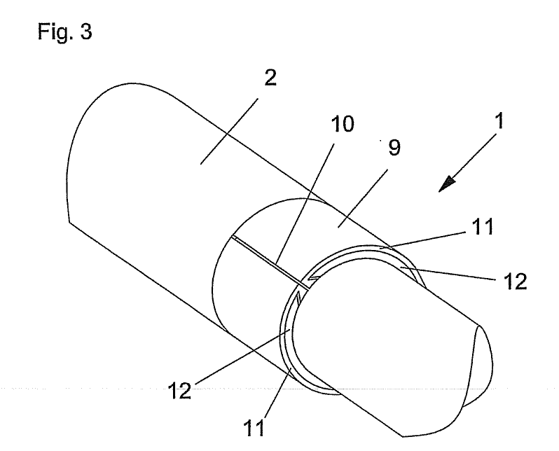

FIG. 3 shows the details of the color-coded ring 9. The ring 9 presents an axially running slit, which, on the side of the internal periphery, presents a dovetail-shaped positive-fit profile 11, which is introduced into the corresponding counter-profile 12 of the handle base. The ring 9 is held by friction on the handle base 2.

1. Handle for a cleaning device, comprising at least one handle base, with at least two axially adjacent handle sections, the first handle section is of convex design and the second handle section is of concave design, and in that the first handle section presents a higher coefficient of static friction than the second handle section.

2. Handle according to claim 1, wherein the first handle section presents a greater diameter than the second handle section.

3. Handle according to claim 1 wherein the first handle section presents greater surface roughness than the second handle section.

4. Handle according to claim 1, wherein the first handle section is formed from a thermoplastic elastomer, and the second handle section is formed from a thermoplastic.

5. Handle according to claim 4, wherein the material of the first handle section presents a lower Shore hardness than the material of the second handle section.

6. Handle according to claim 1, wherein the free end of the handle presents a spherical segment-like third handle section, which is made of the same material as the second handle section.

7. Handle according to claim 1, wherein an additional handle base, which presents at least one additional handle sections of convex and concave design, is associated with the middle section of the handle.

8. Handle according to claim 7, wherein the additional handle sections are made of the same material.

9. Handle according to claim 1, wherein a color-coded ring is associated with the handle.

10. Handle according to claim 9, wherein the ring presents an axially running slit, where the slit presents, on the side of the internal periphery, a positive-fit profile which can be introduced into a corresponding counter-profile of the hollow body.
